(19) United States
(12) Patent Application Publication
(10) Pub. No.: US 2026/0252178 A1
(43) Pub. Date: Aug. 27, 2026

(54) AERIAL IMAGE DISPLAY DEVICE CAPABLE OF MANIPULATING THREE-DIMENSIONAL OBJECT BY TOUCHING IT

(71) Applicant: INTERMAN Corporation, Kagoshima-shi (JP)

(72) Inventor: Naofumi HIGASHIKAWAUCHI, Kagoshima-shi (JP)

(73) Assignee: INTERMAN Corporation, Kagoshima-shi (JP)

(21) Appl. No.: 19/537,948

(22) Filed: Feb. 12, 2026

(30) Foreign Application Priority Data
Feb. 27, 2025 (JP) 2025-029676

(51) Int. Cl. G06F 3/01; G02B 30/56; G06F 3/04815; G06F 3/04845

(52) U.S. Cl. CPC G06F 3/017; G02B 30/56; G06F 3/011; G06F 3/04815; G06F 3/04845

(57) ABSTRACT

An aerial image display device is described that allows users to freely manipulate a three-dimensional object floating in mid-air with their hand movements. A spherical touching region is defined to encompass the three-dimensional object projected in mid-air by the aerial image display device. A motion sensor installed in this aerial image display device detects the user's hand movements, and when these hand movements occur within the defined touching region, the three-dimensional object rotates in synchronization with these hand movements. Conversely, when the user's hand movements occur outside the touching region, these hand movements have no effect on the movement of the three-dimensional object.

The present application claims priority under 35 U.S.C. § 119 to Japanese Patent Application No. P2025-029676, filed on Feb. 26, 2025 including description, claims, drawings, and abstract. The contents of this application are herein incorporated by reference in their entirety.

### FIELD

This invention relates to an aerial image display device capable of naturally manipulating a three-dimensional object floating in mid-air by physically interacting with them.

### BACKGROUND

An aerial image display device is a device that projects object images into empty space. For instance, Re-Published Japanese Patent Application No. 2018/139141 describes an aerial image display device that projects images by utilizing light reflection. When displaying objects as aerial images, viewers perceive them as floating above the surroundings, creating a sense of three-dimensional depth. Particularly when using perspective projection to display objects from a 3D space, it effectively creates the illusion that the three-dimensional object actually exists in that space.

Most commercially available aerial image display devices currently incorporate three-dimensional motion sensors consisting of an infrared LEDs and infrared cameras. These motion sensors detect users' hand movements in the vicinity of the aerial image, enabling the implementation of an input interface through the aerial image. This allows users to directly manipulate the aerial image by physically touching it. For example, users can move and rotate three-dimensional objects floating in mid-air using their hands.

However, when implementing direct manual manipulation of three-dimensional objects floating in mid-air, there can be cases where the objects don't move as intended. While the three-dimensional motion sensors can accurately detect hand movements, the user's perceived three-dimensional vision is not as precise. This is likely because the aerial images displayed by the device are projected onto a flat plane, resulting in insufficient depth perception. Additionally, even when the user's hand is positioned where they believe they are touching the three-dimensional object, they may actually not be feeling any tactile feedback.

As a result, users may think they are touching part of a three-dimensional object when in fact they are not, or conversely, they may unintentionally touch a protruding part of the object and cause it to move significantly.

For instance, Japanese Patent Application No. 2025-9661 describes an aerial image display device equipped with a detection mechanism for detecting users' aerial manipulation of floating images. However, for spatial manipulation detection, it calculates the contact position between the user's fingers and the object. As mentioned above, this sometimes prevents users from performing manipulations as intended.

Therefore, it is an object of the present invention to provide an aerial image display device that allows users to manipulate three-dimensional objects floating in mid-air through direct physical contact while minimizing any sense of discomfort.

### SUMMARY

To achieve at least one of the above-mentioned objects, reflecting one aspect of the present invention, a computer-implemented method is provided for displaying aerial images by an aerial image display device which comprises: a computer; a visual system controlled by this computer to project images into the air as the aerial images; and a motion sensor that detects coordinates of a user's hand near the projected aerial image and transmits the detection results to the computer, the method comprising: a step of controlling the visual system to project a three-dimensional object with a convex portion as an aerial image; a step of defining a three-dimensional touching region that is larger than the three-dimensional object and completely encompasses the entirety of the three-dimensional object; a step of determining whether or not a user's hand moves within the three-dimensional touching region with reference to the coordinates of the user's hand detected by the motion sensor; a step of projecting, as an aerial image, the movement of the three-dimensional object in correspondence with the movement of the user's hand when, in the determining step, it is determined that the user's hand moves within the three-dimensional touching region; a step of projecting, as an aerial image, the three-dimensional object whose motion is not influenced by the movement of the user's hand when, in the determining step, it is determined that the user's hand moves outside the three-dimensional touching region.

In accordance with one embodiment, the three-dimensional touching region is a spherical region or an approximately elliptical region containing the three-dimensional object.

Also, in accordance with one embodiment, in the step of projecting the movement of the three-dimensional object, the three-dimensional object is rotated around its center point in response to the user's hand movement.

Furthermore, in accordance with one embodiment, the user's hand movement is detected with reference to the movements of multiple fingertips, and the average rotation corresponding to these fingertip movements is reflected in the rotation of the three-dimensional object.

In accordance with another aspect of the present invention, an aerial image display device comprises a computer; a visual system controlled by this computer to project images into the air as aerial images; and a motion sensor that detects the coordinates of a user's hand performed near the projected aerial image and transmits the detection results to the computer, the computer being configured to perform: a step of controlling the visual system to project a three-dimensional object with a convex portion as an aerial image; a step of defining a three-dimensional touching region that is larger than the three-dimensional object and completely encompasses the entirety of the three-dimensional object; a step of determining whether or not a user's hand moves within the three-dimensional touching region with reference to the coordinates of the user's hand detected by the motion sensor; a step of projecting, as an aerial image, the movement of the three-dimensional object in correspondence with the movement of the user's hand when, in the determining step, it is determined that the user's hand moves within the three-dimensional touching region; a step of projecting, as an aerial image, the three-dimensional object whose motion is not influenced by the movement of the user's hand when, in the determining step, it is determined that the user's hand moves outside the three-dimensional touching region.

In accordance with a further aspect of the present invention, a computer-readable storage device is configured with data and instructions which upon execution by a computer cause an aerial image display device to display an aerial image according to a display process, the aerial image display device including a visual system for projecting an image into the air as the aerial image; and a motion sensor that detects the coordinates of a user's hand performed near the projected aerial image and transmits the detection results to the computer, the display process comprising: a step of controlling the visual system to project a three-dimensional object with a convex portion as an aerial image; a step of defining a three-dimensional touching region that is larger than the three-dimensional object and completely encompasses the entirety of the three-dimensional object; a step of determining whether or not a user's hand moves within the three-dimensional touching region with reference to the coordinates of the user's hand detected by the motion sensor; a step of projecting, as an aerial image, the movement of the three-dimensional object in correspondence with the movement of the user's hand when, in the determining step, it is determined that the user's hand moves within the three-dimensional touching region; a step of projecting, as an aerial image, the three-dimensional object whose motion is not influenced by the movement of the user's hand when, in the determining step, it is determined that the user's hand moves outside the three-dimensional touching region.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is an exemplary perspective view showing an embodiment of an aerial image display device for executing the program according to the present invention.

FIG. 2 is a cross-sectional view along line A-A of FIG. 1, showing the aerial image display device 1 in use.

FIG. 3 illustrates an exemplary implementation of the aerial image display device for executing the program according to the present invention, depicting a user rotating a three-dimensional object displayed in the air by physically interacting with it.

FIG. 4 is a flowchart explaining the operation of an embodiment of the program according to the present invention, showing the process of rotating a three-dimensional object displayed in the air by physically interacting with it.

### DETAILED DESCRIPTION

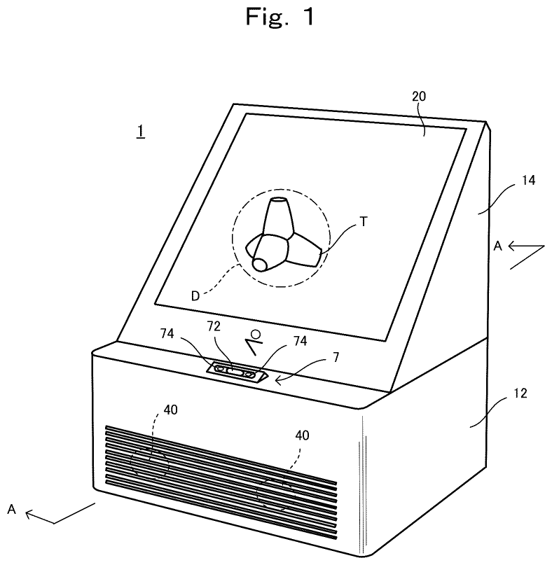

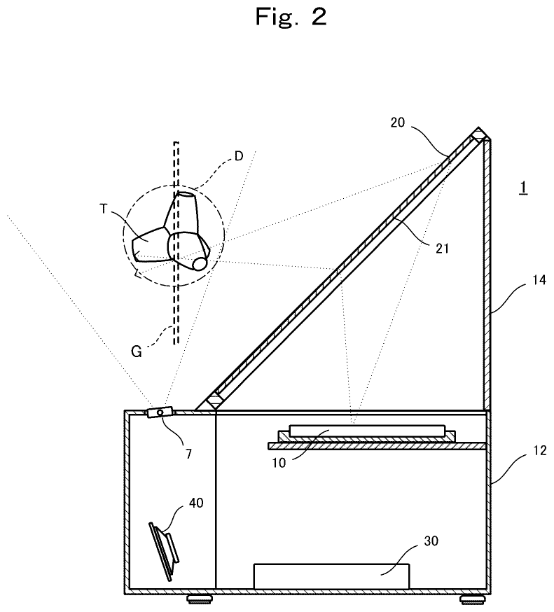

In what follows, an embodiment of a program for an aerial image display device according to the present invention will be described with reference to the accompanying drawings. FIG. 1 shows an aerial image display device 1 for implementing the embodiment of the present invention. FIG. 2 is a cross-sectional view along line A-A of FIG. 1, showing the aerial image display device 1 in use.

As shown in FIGS. 1 and 2, the aerial image display device 1 includes essential components: a liquid crystal display 10 and an optical plate 20. The liquid crystal display 10 and the optical plate 20 consistute a visual system for projecting an image into the air. The device further incorporates an information processing device 30 for controlling the liquid crystal display 10, as well as speakers 40. Here, the liquid crystal display 10, speakers 40, and information processing device 30 are housed within the lower housing 12 and are connected via signal lines (not shown in the figures).

The information processing device 30 is essentially a compact computer composed of components including a CPU (Central Processing Unit), ROM (Read Only Memory), RAM (Random Access Memory), a storage device for storing various programs and data, and input/output interfaces. The storage device is a computer-readable storage medium including instructions, which when executed by the CPU, cause the CPU to perform operations necessary for the program as explained in details in the following description. Input/output interfaces implemented include, for example, USB ports and wireless LAN such as Wi-Fi. The information processing device 30 outputs video signals to the liquid crystal display 10, thereby generating the display that forms the basis for the aerial image. Additionally, it outputs audio signals to the speakers 40, producing guidance voices and other sound effects. This information processing device 30 can also be a commercially available generic compact personal computer or a general-purpose tablet.

The liquid crystal display 10 is housed within the lower housing 12, which features a rectangular planar shape with an open top, and is mounted nearly horizontally with its display screen facing upward. The optical plate 20 is fitted into the upper housing 14 with its incident surface 21 facing downward, positioned at an oblique angle to face the display screen of the liquid crystal display 10. In this case, the optical plate 20 and liquid crystal display 10 are fixed at a roughly 45-degree angle.

For such an optical plate 20, a retro-transmissive optical imaging element (two-face orthogonal reflector) as described in Japanese Unexamined Patent Application Publication No. 2011-175297 can be used. This optical imaging element is realized by arranging numerous mutually orthogonal planar light reflection surfaces at regular intervals. Alternatively, a structure such as a two-surface corner reflector with reflective surfaces on the sides of rectangular holes, as described in Japanese Patent No. 4900618, may be used.

Meanwhile, the upper housing 14 that constitutes the aerial image display device 1 is designed to be easily separated from the lower housing 12. Separating the upper housing 14 facilitates easier maintenance and adjustment of the interior of the lower housing 12, while also reducing the height required for transportation.

As shown in FIG. 2, light emitted from the display screen of the liquid crystal display 10 enters the optical plate 20, reflects twice within it, and then exits on the opposite side. As a result, with the optical plate 20 as a symmetrical surface, an aerial image is formed or projected as a real image in the space on the opposite side. Namely, an aerial imaging system is implemented with the optical plate 20 and the liquid crystal display 10. In this case, to achieve clearer aerial images, it is desirable to prevent external light from interfering with the light from the liquid crystal display 10. In FIG. 2, the reference symbol G indicates the imaging area corresponding to the display surface of the liquid crystal display 10.

Furthermore, in front of the lower housing 12, a three-dimensional motion sensor 7 consisting of an infrared LED 72 and a pair of infrared cameras 74 is installed. This motion sensor 7 precisely detects users' hand movements in three-dimensional space. The detection range of the motion sensor 7 is determined by the emission angle of the infrared LED 72 and the viewing angle of the infrared cameras 74. Such a motion sensor 7 can be a commercially available product, such as the Leap Motion Controller 2 sold by Ultraleap Ltd.

In particular, this three-dimensional motion sensor 7 is mounted so that its tilt angle can be adjusted. That is, the motion sensor 7 is housed in a mounting component that allows it to rotate within a fixed angular range (here, ±20 degrees) around a rotation axis perpendicular to the page of the cross-sectional view shown in FIG. 2. Here, the detection center of the motion sensor 7 is intentionally offset toward the user side compared to the center of the imaging area G. This adjustment maximizes the effective operational detection range. Typically, the detection range of the motion sensor 7 is designed to encompass the entire area of the aerial image's imaging region G.

Not shown here, but for optimal viewing of aerial images at eye level, it is advisable to place the aerial image display device 1 on a table of appropriate height. In particular, it is desirable to provide the table with a lifting device that allows the height of the table to be freely adjusted. An example of such a lifting device is an electric lifting device named “Mario N” sold by Yamato Metal Manufacturing Co., Ltd.

Typically, such aerial image display devices are used as input devices for administrative systems like reception systems. That is, by displaying a non-contact interface screen as an aerial image, users can perform gesture-based operations such as touching the screen with their fingers. The motion sensor 7, consisting of the infrared LED 72 and infrared cameras 74, detects these operations, and the corresponding operation signals are sent to the information processing unit 30, where predetermined processing is performed. The operation interface includes controls such as buttons, checkboxes, and drop-down menus. Thus, a completely non-contact interface can be realized with the same intuitive usability as conventional touch panels.

In the present invention, this aerial image display device is used to display three-dimensional objects rendered in 3D CG for entertainment or educational purposes. The three-dimensional objects are depth-perceptible images created by projecting the three-dimensional objects defined in computer-simulated space onto the screen of a liquid crystal display 10 through perspective projection. Furthermore, by projecting the liquid crystal display 10's screen directly in front of the user, this computer-simulated three-dimensional space becomes correspond to the three-dimensional space in front of the user.

Here, a tetrapod is illustrated as an example of the three-dimensional object. Although FIG. 2 depicts a tetrapod viewed from the side, the actual aerial image display device 1 does not show the tetrapod in this way when viewed from the side. The original liquid crystal display 10 is flat, and the tetrapod is projected onto the flat imaging plane as a perspective projection diagram. Thereby, the tetrapod is virtually depicted here within the three-dimensional space represented as a perspective projection diagram here.

This three-dimensional object can be controlled in its orientation through hand gestures directed at the object itself. The three-dimensional object T is displayed at the center of the imaging area G. That is, by fixing the center point (center of mass) of the three-dimensional object T at the center of the imaging area G, the object's movement freedom is limited to only three-dimensional rotational freedom.

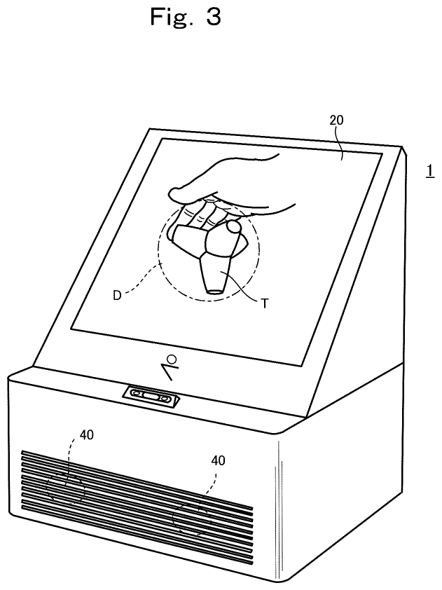

Controlling the rotation of the three-dimensional object T through gestures is performed in a manner similar to gently stroking and moving the surface of the floating three-dimensional object T (see FIG. 3). When the coordinates of the user's hand detected by the motion sensor 7 are found inside the object's surface, it is determined that there is an interference between the user's hand and the three-dimensional object T, and the object is then rotated in accordance with the user's hand movements. However, in such cases, the unevenness of the object's surface may lead to intermittent detection of interference. As a result, the user may not be able to perform the desired rotation smoothly.

Therefore, in the present invention, a spherical detection region D is defined encompassing the three-dimensional object T to enable intuitive rotation control without requiring the user to consider the object's shape. Instead of using the three-dimensional object T itself, this spherical detection region D is used to determine interference with the user's hand. In other words, the detection region D is a touching region such that, if the user's hand is entering the touching region, it is assumed that the user touches the three-dimensional object T to move (rotate) the three-dimensional object T in response to the movement of the hand.

The center of the spherical detection region D is aligned with the center point (rotational center) of the three-dimensional object T, and its radius is sufficiently large to encompass the entire object. For example, the distance from the center to the most distant point of the three-dimensional object T could be used as the radius of the spherical detection region D.

When the system is activated, repeated acquisition of the user's hand coordinates detected by the motion sensor 7 is performed. For each coordinate acquisition, a check is then performed to determine if the coordinate point lies within the detection region D. If the hand coordinate point is inside the detection region D, the movement of the user's hand is calculated. Here, the hand movement is calculated as the coordinate difference between the previously acquired coordinate point and the current coordinate point. The calculated hand movement is then converted into a rotation vector with the three-dimensional object T's center (rotational center) as the origin, and the object is rotated and redrawn accordingly. In this way, the user's hand movements can be accurately reflected in the rotation of the three-dimensional object T.

If the user's hand coordinate point acquired by the motion sensor 7 is outside the detection region D, a check is then performed to determine if the previous coordinate acquisition was within the detection region D. If the previous coordinate acquisition was not inside the detection region D, no special processing is performed, and the system simply continues repeating the hand coordinate acquisition. If the previous coordinate acquisition was inside the detection region D, it is assumed that the user has touched the three-dimensional object T with their hand, rotated it, and then removed their hand while maintaining the rotation.

In other words, the rotation speed of the three-dimensional object T is calculated from the difference between the current and previous coordinate acquisitions. After the user's hand exits the detection region D, the three-dimensional object T continues to rotate at this speed independently of any further hand movements. However, this rotation speed gradually decays according to a predetermined damping coefficient.

When the user wants to stop a three-dimensional object T in a specific orientation, they should pull their hand straight outward from the center along the radius, without rotating the object, to properly maintain the desired position. To detect this intention, the radial component of the difference between the current and previous coordinates is compared with the remaining component (the tangential component). If the radial component is greater than the tangential component, we disregard the tangential component (effectively setting it to zero) and fix the three-dimensional object T at its current position. Conversely, if the radial component is not greater than the tangential component, the object T will rotate according to the tangential component.

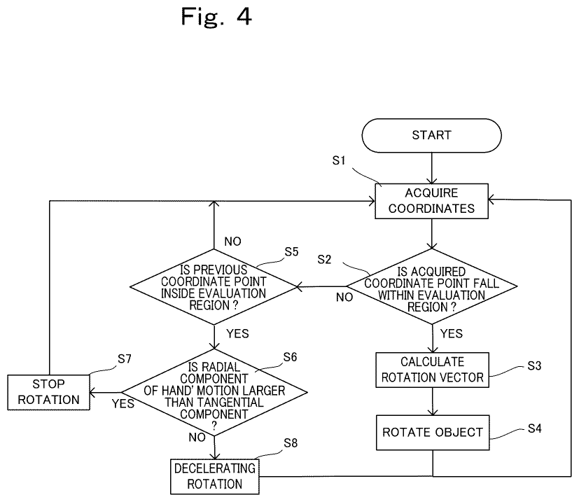

To explain the overall process in greater detail, refer to the flowchart in FIG. 4. First, in Step S1, the motion sensor 7 acquires the coordinates of the user's hand. Here, coordinates of the fingertips are acquired. Therefore, when using both hands, up to ten coordinate points can be acquired. Note that the center of the three-dimensional object T as displayed serves as the rotation center, the center of the imaging region, and the origin of the coordinate system. The vector from this coordinate system origin to each coordinate point is called the coordinate vector.

Next, in Step S2, we determine whether the acquired coordinate point falls within the evaluation region D. If at least one coordinate point is determined to be inside the evaluation region D (Step S2: YES), the user's hand movement is calculated as the difference between the current and previous values for each coordinate point inside the evaluation region, to determine the rotation vector v that corresponds to the hand movement (Step S3).

Specifically, the individual rotation vectors vi (where index i ranges from 1 to n: maximum 10) is calculated by using the current coordinate vector rᵢ and the previous coordinate vector rᵢ′. In this case, using cross product X, the rotation vectors vᵢ is roughly calculated as vᵢ=(rᵢ×rᵢ′)/|rᵢ|. Assuming the rotation vectors vᵢ are very small, we define the sought rotation vector v is defined as the average of these vectors, i.e., Σvᵢ=/n.

Next, using the calculated rotation vector v, the 3D object T is rotated (Step S4). That is, for each point p of the 3D object T, the rotated point p′ is calculated using the following formula: Here, X denotes the cross product and · represents the inner product.

$${p}^{′} = p cos \vert v \vert + \vert v \vert - 2 v ( v \cdot p ) ( 1 - cos \vert v \vert ) + \vert v \vert - 1 ( v \times p ) sin \vert v \vert$$

If in Step S2 it is determined that all acquired coordinate points lie outside the evaluation region D (Step S2: NO), it is checked whether any of the previous coordinate points was inside the evaluation region D (Step S5). If any previous coordinate point was inside the evaluation region D (Step S5: YES), it is concluded that the user has touched the 3D object T with their hand to rotate it, then removed their hand from the object.

In the case where Step S5 yields YES, the radial and tangential components of the difference (rᵢ′−rᵢ) between the current and previous coordinate points are compared (Step S6). This can be determined by calculating both the cross product and inner product of the current coordinate vector and the difference, then comparing which value is larger.

Specifically, if (rᵢ′−rᵢ)·rᵢ>|(rᵢ′−rᵢ)×rᵢ|, it is judged that the radial component is dominant (Step S6: YES), and stop the rotation of 3D object T to lock it at its current position (Step S7). This allows the user to intentionally stop the 3D object T in a specific orientation by pulling their hand out of the evaluation region D.

If (rᵢ′−rᵢ)·rᵢ≤|(rᵢ′−rᵢ)×rᵢ|, it is concluded that the tangential component is dominant (Step S6: NO), indicating that the user intends to continue freely rotating the 3D object T even after removing their hand. Therefore, from the coordinate vectors rᵢ and rᵢ′, the rotation vector v is calculated as described above. Even after the user moves their hand outside the evaluation region D, the 3D object T will continue to rotate according to the rotation vector v.

The rotation vector v corresponds to angular velocity ω(=|v|/d) based on the coordinate acquisition interval d. While it is possible to continue rotating the 3D object T at this angular velocity ω, in reality, even objects floating in the air gradually lose rotational speed due to air resistance. Therefore, a decay simulation is implemented here as well (Step S8).

Air resistance is proportional to angular velocity ω, so the motion equation becomes: Cω=−Mdω/dt, where C is the coefficient and M is the moment of inertia. To implement this, the display of the 3D object T is updated at each coordinate acquisition interval d, simply multiplying the angular velocity ω by a constant decay factor at each interval d. For example, with a decay factor of 0.9, the angular velocity will approximately halve every 7 intervals. By increasing this decay factor, the object will come to a stop more gradually.

As described above, with the aerial image display device according to the present invention, by setting an evaluation region D that encompasses the displayed 3D object, users can operate the object with their hand without experiencing any unintended discomfort.

The above implementation also supports operation using both hands. For instance, if the left hand remains stationary within the evaluation region D while the right hand performs rotations on the 3D object, the movements of both hands are averaged, allowing operations like applying braking with the left hand while controlling more precise movements with the right hand.

Note that the detected hand movements correspond to the difference vector between the current and previously acquired coordinate vectors. In the above implementation, if the current coordinate point falls within the evaluation region, it is considered hand movement inside the region. However, if the previous coordinate point falls within the evaluation region, considering it hand movement inside the region is also possible.

In other words, when the current and previously acquired coordinate points cross the evaluation region boundary, the hand movement is considered to be on the boundary itself. Whether this is interpreted as movement inside the region or outside the region does not cause any significant issues.

Finally, let's clarify the spatial regions involved in the present invention. First, there's the object region, which is the space occupied by the 3D object. Traditionally, detection systems would determine whether the coordinate point of the detected user's hand was in contact with this object region, then decide whether to execute object manipulation based on that result.

However, in the present invention, any detection is not performed to determine whether the hand (or, in the above implementation, the fingertips) is in contact with the object region. Instead, a 3D evaluation region is defined that completely encompasses the 3D object. It is determined whether the detected coordinate point of the user's hand is in contact with this evaluation region, specifically, whether they lie within its interior. If contact is detected, object manipulations such as rotation will be executed.

The key difference from conventional technology lies in the peripheral space outside the object region but inside the evaluation region. As previously explained, with conventional systems, operations performed in this peripheral space could cause irregular movements in 3D objects with uneven surfaces. In accordance with the present invention, even when performing intuitive operations without worrying about the object's uneven surfaces, the hand's position will generally remain within this peripheral space, enabling operations to be performed as intended.

Note that while hand position detected within the peripheral space triggers object manipulation, as in the above implementation, if the hand position falls within the object region occupied by the 3D object, it will still be considered inside the evaluation region, thereby triggering object manipulation.

In a typical implementation, the imaging region G is smaller than the detection range of the motion sensor, and the 3D object is sized such that its entire perspective projection fits entirely within the imaging region G. Additionally, the entire evaluation region is contained within the motion sensor's detection range. Furthermore, the evaluation region is sized such that its entire projection falls within the imaging region G.

The aerial image display device according to the present invention enables users to move 3D objects floating in mid-air directly by hand, without any sense of discomfort.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

In the above example, the evaluation region D is spherical in shape, but this is not a strict requirement of the present invention. For instance, the region could be elliptical, oblate, or prolate in shape, or generally any region larger than the displayed 3D object that completely encompasses it. Specifically, the region can be configured as any polyhedron or other shape that matches the shape of the displayed 3D object.

Here, the aerial image display device 1 includes an information processing device 30, but this is not a strict requirement of the present invention. For example, the information processing device 30 could be omitted, and the aerial image display device 1 could be equipped with external input terminals for video signals to the LCD display 10 and audio input terminals for voice signals to the speakers, with the necessary video and audio signals being supplied from external computers or other sources.

In the above example, a three-dimensional motion sensor consisting of an infrared LED and infrared cameras is employed, but this is not a strict requirement of the present invention; tracking could also be performed using conventional cameras that detect visible light.

Furthermore, in the above example, an aerial image display device using a retro-transmissive optical imaging element is employed. However, while the present invention is not limited to such devices, for example, an aerial image display device using a retroreflective optical imaging element could also be employed.

Additionally, while the above example employs an LCD display, this is not a strict requirement of the present invention, but other display technologies such as organic EL displays or backlit electronic paper could also be used.

What is claimed is:

1. A computer-implemented method for displaying aerial images by an aerial image display device which comprises: a computer; a visual system controlled by this computer to project images into the air as the aerial images; and a motion sensor that detects coordinates of a user's hand near the projected aerial image and transmits the detection results to the computer, the method comprising:
a step of controlling the visual system to project a three-dimensional object with a convex portion as an aerial image;
a step of defining a three-dimensional touching region that is larger than the three-dimensional object and completely encompasses the entirety of the three-dimensional object;
a step of determining whether or not a user's hand moves within the three-dimensional touching region with reference to the coordinates of the user's hand detected by the motion sensor;
a step of projecting, as an aerial image, the movement of the three-dimensional object in correspondence with the movement of the user's hand when, in the determining step, it is determined that the user's hand moves within the three-dimensional touching region;
a step of projecting, as an aerial image, the three-dimensional object whose motion is not influenced by the movement of the user's hand when, in the determining step, it is determined that the user's hand moves outside the three-dimensional touching region.

2. The computer-implemented method as claimed in claim 1 wherein the three-dimensional touching region is a spherical region or an approximately elliptical region containing the three-dimensional object.

3. The computer-implemented method as claimed in claim 1 wherein, in the step of projecting the movement of the three-dimensional object, the three-dimensional object is rotated around its center point in response to the user's hand movement.

4. The computer-implemented method as claimed in claim 1 wherein the user's hand movement is detected with reference to the movements of multiple fingertips, and the average rotation corresponding to these fingertip movements is reflected in the rotation of the three-dimensional object.

5. An aerial image display device comprising a computer; a visual system controlled by this computer to project images into the air as aerial images; and a motion sensor that detects the coordinates of a user's hand performed near the projected aerial image and transmits the detection results to the computer, the computer configured to perform:
a step of controlling the visual system to project a three-dimensional object with a convex portion as an aerial image;
a step of defining a three-dimensional touching region that is larger than the three-dimensional object and completely encompasses the entirety of the three-dimensional object;
a step of determining whether or not a user's hand moves within the three-dimensional touching region with reference to the coordinates of the user's hand detected by the motion sensor;
a step of projecting, as an aerial image, the movement of the three-dimensional object in correspondence with the movement of the user's hand when, in the determining step, it is determined that the user's hand moves within the three-dimensional touching region;
a step of projecting, as an aerial image, the three-dimensional object whose motion is not influenced by the movement of the user's hand when, in the determining step, it is determined that the user's hand moves outside the three-dimensional touching region.

6. A computer-readable storage device configured with data and instructions which upon execution by a computer cause an aerial image display device to display an aerial image according to a display process, the aerial image display device including a visual system for projecting an image into the air as the aerial image; and a motion sensor that detects the coordinates of a user's hand performed near the projected aerial image and transmits the detection results to the computer, the display process comprising:
a step of controlling the visual system to project a three-dimensional object with a convex portion as an aerial image;
a step of defining a three-dimensional touching region that is larger than the three-dimensional object and completely encompasses the entirety of the three-dimensional object;
a step of determining whether or not a user's hand moves within the three-dimensional touching region with reference to the coordinates of the user's hand detected by the motion sensor;
a step of projecting, as an aerial image, the movement of the three-dimensional object in correspondence with the movement of the user's hand when, in the determining step, it is determined that the user's hand moves within the three-dimensional touching region;
a step of projecting, as an aerial image, the three-dimensional object whose motion is not influenced by the movement of the user's hand when, in the determining step, it is determined that the user's hand moves outside the three-dimensional touching region.
